(19) United States
(12) Patent Application Publication
(10) Pub. No.: US 2014/0006810 A1
(43) Pub. Date: Jan. 2, 2014

(54) POWER SUPPLY CIRCUIT FOR HARD DISK DRIVE

(71) Applicants: Bo TIAN, Shenzhen City (CN); Kang WU, Shenzhen City (CN)

(72) Inventors: Bo TIAN, Shenzhen City (CN); Kang WU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/572,657

(22) Filed: Aug. 12, 2012

(30) Foreign Application Priority Data
Jun. 29, 2012 (CN) 2012102211417

(51) Int. Cl. G06F 1/26

(52) U.S. Cl. 713/300

(57) ABSTRACT

A power supply circuit includes a main control circuit and a number of switching control circuits. The main control circuit receives working status signals from hard disk drives (HDDs), and outputs control signals according to the working status signals. Each switching control circuit is connected between a power supply unit and a HDD connector for connecting to one of the HDDs. The switching control circuit reconnects or disconnects power to or from the HDD connector according to the control signals.

### BACKGROUND

1. Technical Field

The present disclosure relates to a circuit for supplying power to hard disk drives.

2. Description of Related Art

As digital information increases, the need for storage space increases. Most of this storage space is provided by hard disk drives (HDDs). As a result, more and more HDDs are mounted to servers to store the information. In a server, a power supply unit (PSU) supplies power to the HDDs. In this condition, if one of the HDDs is not operating, the PSU continues supplying power for the non-operating HDD. Energy is consumed and wasted.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a power supply circuit, wherein the power supply circuit includes a main control circuit, a re-powering circuit, and a switching control circuit.

FIG. 2 is a circuit diagram of the main control circuit of FIG. 1.

FIG. 3 is a circuit diagram of the re-powering circuit and the switching control circuit of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at “least one”.

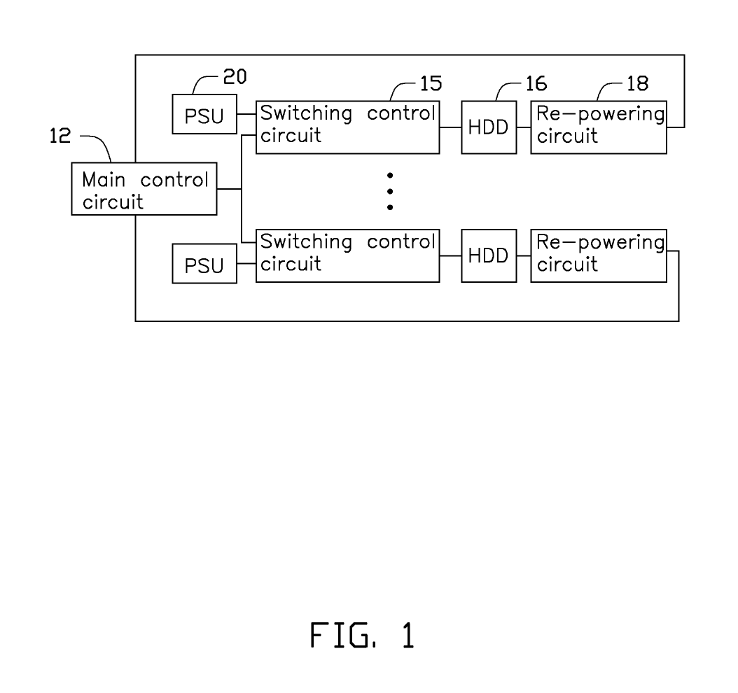

Referring to FIG. 1, an exemplary embodiment of a power supply circuit for a plurality of hard disk drives (HDDs) 16 includes a main control circuit 12, a plurality of switching control circuits 15, and a plurality of re-powering circuits 18.

In many servers, a HDD controller controls the HDDs 16, and transmits working status signals of each HDD 16 through serial general purpose input/output (SGPIO) pins of the HDD controller. In the embodiment, the main control circuit 12 receives the working status signals from the SGPIO pins. The main control circuit 12 further outputs control signals to the switching control circuits 15 according to the working status signals. Each switching control circuit 15 is connected between a power supply unit (PSU) 20 and one of the HDDs 16. The switching control circuit 15 connects or disconnects the PSUs 20 to or from the HDDs 16 according to the control signals.

Each re-powering circuit 18 determines whether a non-operated HDD 16 is replaced, and outputs a detection signal to the main control circuit 12 when the non-operated HDD 16 is replaced. The main control circuit 12 receives the detection signal and outputs a control signal to the switching control circuit 15. The switching control circuit 15 connects the PSU 20 and the replaced HDD 16.

In the embodiment, the server includes four HDDs 16, the switch controlling circuits 15 are four in number, and the re-powering circuits 18 are four in number.

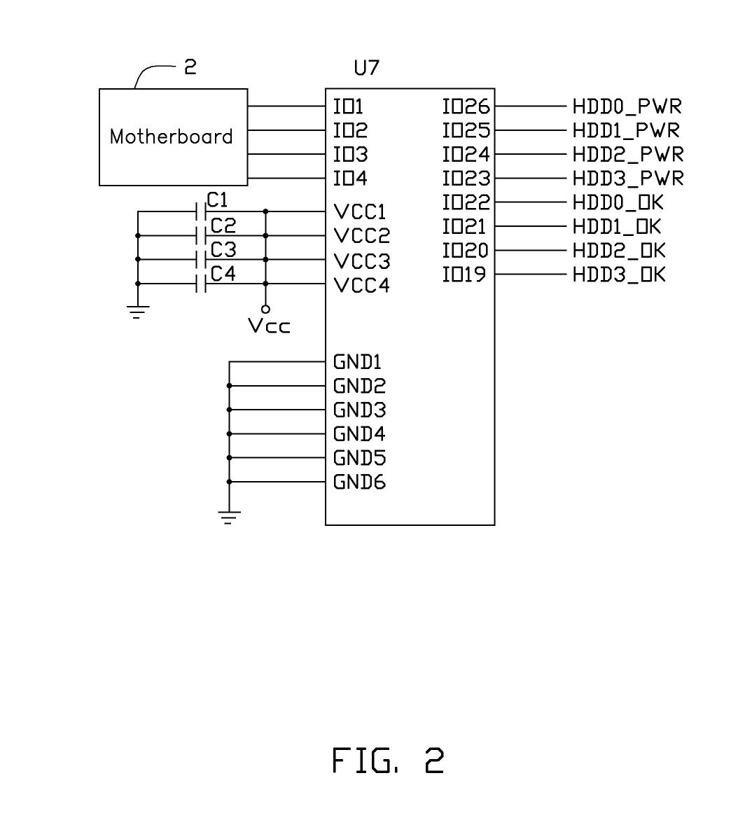

Referring to FIG. 2, the main control circuit 12 includes a main control chip U7. A group of first input/output (I/O) pins IO1, IO2, IO3, and IO4 of the main control chip U7 are connected to a motherboard 2, for receiving the working status signals of the HDDs 16. A group of second I/O pins IO23, IO24, IO25, and IO26 of the main control chip U7 respectively output control signals HDD3_PWR, HDD2_PWR, HDD1_PWR, and HDD0_PWR. A group of third I/O pins IO19, IO20, IO21, and IO22 of the main control chip U7 are connected to the four re-powering circuits 18, for determining whether a HDD 16 has been replaced.

Four power pins VCC1-VCC4 of the main control chip U7 are connected to a power supply Vcc. The power pins VCC1-VCC4 are grounded respectively through four capacitors C1-C4. All the ground pins, GND1-GND6, of the main control chip U7 are grounded.

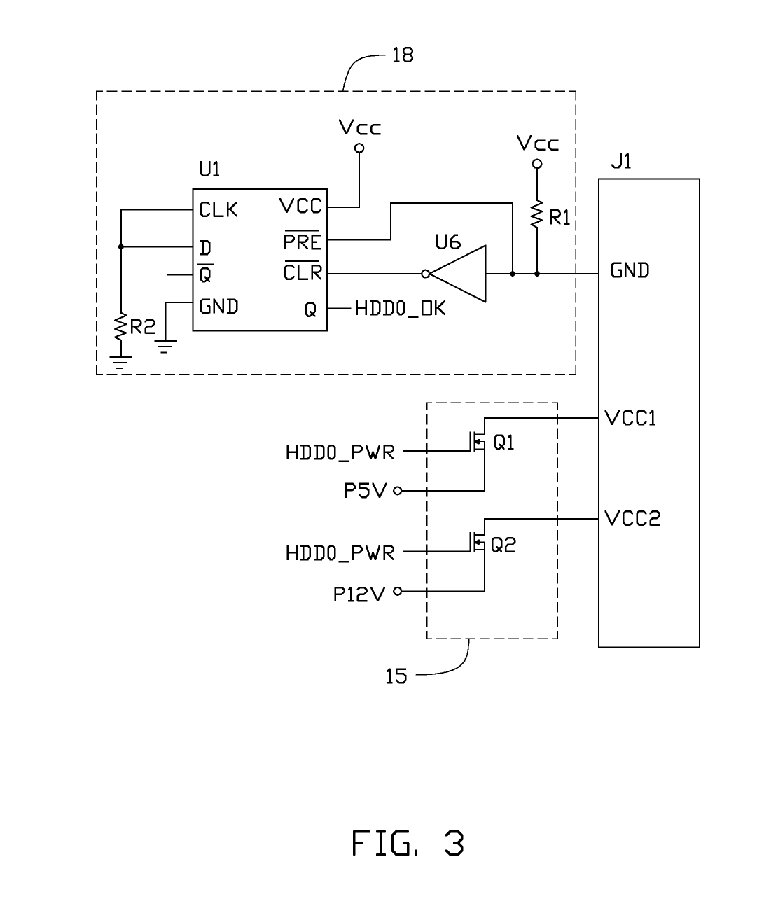

Referring to FIG. 3, each switching control circuit 15 includes two field-effect transistors (FETs) Q1 and Q2. A gate of the FET Q1 is connected to one of the second I/O pins IO23-IO26 of the main control chip U7 (FIG. 3 shows the gate of the FET Q1 connected to the I/O pin IO26), for receiving one of the control signals HDD3_PWR, HDD2_PWR, HDD1_PWR, and HDD0_PWR (FIG. 3 shows the gate of the FET Q1 which receives the control signal HDD0_PWR). A gate of the FET Q2 is connected to the gate of the FET Q1. A source of the FET Q1 is connected to a power supply P5V. A source of the FET Q2 is connected to a power supply P12V. Drains of the FETs Q1 and Q2 are respectively connected to power terminals VCC1 and VCC2 of a HDD connector J1 for connecting to one of the HDDs 16.

Each re-powering circuit 18 includes an inverter U6 and an OR gate chip U1. An input pin of the inverter U6 is connected to a ground pin GND of the HDD connector J1. The input pin of the inverter U6 is further connected to the power supply Vcc through a resistor R1. An output pin of the inverter U6 is connected to an input pin C̅L̅R̅ of the OR gate chip U1. An input pin P̅R̅E̅ of the OR gate chip U1 is connected to the ground pin of the HDD connector J1. A power pin VCC of the OR gate chip U1 is connected to the power supply Vcc. A clock pin CLK of the OR gate chip U1 is grounded through a resistor R2. The clock pin CLK of the OR gate chip U1 is further connected to an output pin D of the OR gate chip U1. A ground pin GND of the OR gate chip U1 is grounded. An output pin Q of the OR gate chip U1 is connected to one of the third I/O pins IO19-IO22 of the main control chip U7 (FIG. 3 shows the output pin Q of the OR gate chip U1 connected to I/O pin IO22). An output pin Q̅ of the OR gate chip U1 is idle.

When the server is powered on, the group of second I/O pins IO23-IO26 output high level control signals HDD3_PWR, HDD2_PWR, HDD1_PWR, and HDD0_PWR. As a result, the gates of the FETs Q1 and Q2 in each switching control circuit 15 receive high level signals. The FETs Q1 and Q2 are turned on. The power supplies P5V and P12V are connected to the HDD connectors J1. The HDDs 16 are powered on.

The group of first I/O pins IO1-IO4 of the main control chip U7 receive the working status signals concerning the HDDs 16, and output correspondingly signals through the group of second I/O pins IO23-IO26. When a first HDD 16 is not operating, the I/O pin IO26 of the main control chip U7 outputs a low level signal HDD0_PWR to the FETs Q1 and Q2. In this condition, the FETs Q1 and Q2 are turned off. The power supplies P5V and P12mV are disconnected from the first HDD 16. As a result, when one of the HDDs 16 in the server is not operating, the PSU 20 stops supplying power to the non-operated HDD 16.

According to characteristics of HDD connectors, when a HDD 16 is plugged into the HDD connector J1, the ground pin GND of the HDD connector J1 outputs a low level signal. When the HDD 16 is removed from the HDD connector J1, the ground pin GND of the HDD connector J1 outputs a high level signal. As a result, when the HDD 16 is removed from the HDD connector J1, the input pin C̅L̅R̅ of the OR gate chip U1 receives a low level signal, and the input pin P̅R̅E̅ of the OR gate chip U1 receives a high level signal. At this time, the output pin Q of the OR gate chip U1 outputs a low level signal. The switch controlling circuit 15 thus continues to withhold power from the HDD connector J1.

When another HDD 16 is plugged into the HDD connector J1, the input pin CLR of the OR gate chip U1 receives a high level signal, and the input pin PRE of the OR gate chip U1 receives a low level signal. In this condition, the output pin Q of the OR gate chip U1 outputs a high level signal HDD0_OK. The main control chip U7 determines that there is a rising edge in the signal HDD0_OK output from the output pin Q of the OR gate chip U1. The main control chip U7 outputs the control signal HDD0_PWR with a high level, such that the switching control circuit 15 connects the HDD 16 to the power supplies P5V and P12V. As a result, after the non-operated HDD 16 is replaced by another HDD 16, the PSU 20 again supplies power.

The foregoing description of the exemplary embodiments of the disclosure has been presented only for the purposes of illustration and description and is not intended to be exhaustive or to limit the disclosure to the precise forms disclosed. Many modifications and variations are possible in the light of everything above. The embodiments were chosen and described in order to explain the principles of the disclosure and their practical application so as to enable others of ordinary skill in the art to utilize the disclosure and various embodiments with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. A power supply circuit, comprising:
a main control circuit operable of receiving working status signals from hard disk drives (HDDs), and outputting corresponding control signals; and
a plurality of switching control circuits, wherein each switching control circuit is connected between a power supply unit and a HDD connector for connecting a corresponding one of the HDDs, and is operable of connecting or disconnecting the power supply unit to or from the HDD connector according to the control signals.

2. The power supply circuit of claim 1, further comprising a plurality of re-powering circuits, wherein each re-powering circuit is connected to a HDD connector, the main control circuit is connected to the re-powering circuits, each re-powering circuit determines whether a new HDD replaces a HDD in one of the HDD connectors, when the re-powering circuit determines that a new HDD replaces the HDD in the HDD connector, the re-powering circuit outputs a detection signal to the main control circuit, the main control circuit outputs a corresponding controlling signal to the switching control circuit for connecting the power supply unit to the HDD connector.

3. The power supply circuit of claim 2, wherein the main control circuit comprises a main control chip, a group of first input output (I/O) pins of the main control chip are connected to a motherboard, for receiving the working status signals of the HDDs; a group of second I/O pins of the main control chip are connected to the switching control circuits, for outputting the control signals to the switching control circuits.

4. The power supply circuit of claim 3, wherein a group of third I/O pins of the main control chip are connected to the re-powering circuits, for determining whether a new HDD replaces a HDD in the HDD connector.

5. The power supply circuit of claim 3, wherein each re-powering circuit comprises an inverter and an OR gate chip, an input pin of the inverter is connected to a ground pin of the HDD connector, the input pin of the inverter is further connected to a third power supply through a first resistor, an output of the inverter is connected to a first input pin of the OR gate chip, a second input pin of the OR gate chip is connected to the ground pin of the HDD connector, a first output pin of the OR gate chip is connected to one of the group of third I/O pins, a second output pin of the OR gate chip is idle; when a HDD is removed from the HDD connector, the second input pin of the OR gate chip receives a high level signal, the first input pin of the OR gate chip receives a low level signal, the first output pin of the OR gate chip outputs a low level signal; when a HDD is plugged into the HDD connector, the second input pin of the OR gate chip receives a low level signal, the first input pin of the OR gate chip receives a high level signal, the first output pin of the OR gate chip outputs a high level signal, a pin of the main control chip connected to the first output pin of the OR gate chip receives a signal with a rising edge, such that the re-powering circuit determines that a new HDD replaces a HDD in the HDD connector.

6. The power supply circuit of claim 1, wherein the power supply unit comprises a first power supply and a second power supply, each switching control circuit comprises first and second field-effect transistors (FETs), a gate of the first FET is connected to the main control circuit, for receiving a corresponding controlling signal; a gate of the second FET is connected to the gate of the first FET, a source of the first FET is connected to the first power supply, a source of the second FET is connected to the second power supply, drains of the first and second FETs are connected to a power terminal of the HDD connector;
wherein when the first and second FETs are turned on, the first and second power supplies are connected to the HDD connector; when the first and second FETs are turned off, the first and second power supplies are disconnected from the HDD connector.
